(19) United States
(12) Patent Application Publication
(10) Pub. No.: US 2025/0320985 A1
(43) Pub. Date: Oct. 16, 2025

(54) TECHNIQUE FOR FIXING CIRCUIT BOARD INSIDE OPTICAL INDICATOR OF JOB-SITE DEVICE

(71) Applicant: MAKITA CORPORATION, Anjo-shi (JP)

(72) Inventors: Takuma IWATANI, Anjo-shi (JP); Makoto CHIKARAISHI, Anjo-shi (JP)

(73) Assignee: MAKITA CORPORATION, Anjo-shi (JP)

(21) Appl. No.: 19/172,797

(22) Filed: Apr. 8, 2025

(30) Foreign Application Priority Data
Apr. 16, 2024 (JP) 2024-066154

(51) Int. Cl. F21V 19/00; A01D 34/82; A01D 34/90; A01D 101/00

(52) U.S. Cl. CPC F21V 19/003; A01D 34/824; A01D 34/90; A01D 2101/00

(57) ABSTRACT

One aspect of the present disclosure provides a job-site device including an optical indicator. The optical indicator includes a container and a circuit board. The container (i) includes a closed end, a peripheral wall, and an open end and (ii) is configured to at least partially transmit light therethrough. The peripheral wall (i) surrounds an internal space of the container between the closed end and the open end and (ii) includes a first protrusion on an inner peripheral surface thereof. The first protrusion (i) protrudes toward the internal space and (ii) is shorter in a direction along a perimeter of the peripheral wall than a perimeter of the inner peripheral surface. The circuit board includes a first surface (i) including a first light source and (ii) facing the closed end. The circuit board is press-fitted in the internal space while pressing the first protrusion toward the inner peripheral surface.

### CROSS-REFERENCE TO RELATED APPLICATIONS

The present application claims the benefit of Japanese Patent Application No. 2024-066154 filed on Apr. 16, 2024 with the Japan Patent Office, the entire disclosure of which is incorporated herein by reference.

### BACKGROUND

The present disclosure relates to a job-site device.

Japanese Patent No. 7129896 discloses a grass cutter with a display at a leading end of a right grip to be gripped by a user. The display includes therein a circuit board on which five light emitting diodes are mounted. The circuit board is fixed inside the display with two screws.

### SUMMARY

It is burdensome to fix the circuit board inside the display with the two screws.

In one aspect of the present disclosure, it is desirable to be able to fix a circuit board inside an optical indicator of a job-site device without use of a screw.

In the present disclosure, languages such as “first” and “second” merely intend to distinguish one element from another. Such languages do not intend to limit the order or the number of elements. Accordingly, a first element may be referred to as a second element; and likewise, a second element may be referred to as a first element. In addition, a first element may be included without a second element; and likewise, a second element may be included without a first element.

One aspect of the present disclosure provides a job-site device including an optical indicator.

The optical indicator includes a container and a circuit board. The container (i) includes a closed end, a peripheral wall, and an open end with an opening and (ii) is configured to at least partially transmit light therethrough.

The peripheral wall (i) surrounds an internal space of the container between the closed end and the open end and (ii) includes a first protrusion on an inner peripheral surface thereof. The first protrusion (i) protrudes toward the internal space and (ii) is shorter in a direction along a perimeter of the peripheral wall than a perimeter of the inner peripheral surface.

The circuit board includes a first surface (i) including a first light source and (ii) facing the closed end. The circuit board is press-fitted in the internal space while pressing the first protrusion toward the inner peripheral surface.

In the job-site device configured as above, the circuit board can be fixed inside the optical indicator without use of a screw.

Another aspect of the present disclosure provides a method for fixing a circuit board inside an optical indicator of a job-site device.

The method includes preparing a container for the optical indicator. The container (i) includes a closed end, a peripheral wall, and an open end and (ii) is configured to at least partially transmit light therethrough. The peripheral wall (i) surrounds an internal space of the container between the closed end and the open end and (ii) includes a protrusion on an inner peripheral surface thereof. The protrusion (i) protrudes toward the internal space and (ii) is shorter in a direction along a perimeter of the peripheral wall than a perimeter of the inner peripheral surface.

The method further includes press-fitting the circuit board in the internal space from the open end while pressing the protrusion with the circuit board toward the inner peripheral surface.

Such a method enables fixation of the circuit board inside the optical indicator of the job-site device without use of a screw.

### BRIEF DESCRIPTION OF THE DRAWINGS

Example embodiments of the present disclosure will be described hereinafter with reference to the accompanying drawings, in which:

FIG. 1 is a perspective view of a job-site device in an example embodiment;

FIG. 2 is a circuit diagram showing a schematic electrical configuration of the job-site device;

FIG. 3 is a perspective view of an optical indicator of the job-site device;

FIG. 4 is a transparent diagram of the optical indicator in FIG. 3;

FIG. 5 is a cross-sectional view of the optical indicator;

FIG. 6 is a bottom view of a container with a filler and a circuit board removed;

FIG. 7 is a perspective view of the container with the filler and the circuit board removed;

FIG. 8 is another perspective view of the container with the filler and the circuit board removed;

FIG. 9A is a top view of the circuit board to be fixed inside the container;

FIG. 9B is a bottom view of the circuit board to be fixed inside the container;

FIG. 10A illustrates a state of the circuit board before it is press-fitted in an internal space of the container;

FIG. 10B illustrates a state of the circuit board when it is press-fitted in the internal space of the container; and

FIG. 11 is a bottom view of a container in one variation.

### DETAILED DESCRIPTION OF EXEMPLARY EMBODIMENTS

### 1. Overview of Embodiments

One embodiment may provide a job-site device (or an outdoor device) that includes at least any one of:
Feature 1: an optical indicator;
Feature 2: the optical indicator includes a container (or a case or a housing);
Feature 3: the container includes a closed end, a peripheral wall (or a surrounding wall), and an open end with an opening;
Feature 4: the container is configured to at least partially transmit light therethrough;
Feature 5: the peripheral wall surrounds (or encloses) an internal space of the container between the closed end and the open end;
Feature 6: the peripheral wall includes a first protrusion on an inner peripheral surface thereof;
Feature 7: the first protrusion protrudes toward the internal space;
Feature 8: the first protrusion is shorter in a direction along a perimeter of the peripheral wall (or the inner peripheral surface) than a perimeter of the inner peripheral surface;
Feature 9: the optical indicator includes a circuit board;
Feature 10: the circuit board includes a first surface;
Feature 11: the first surface includes a first light source;
Feature 12: the first surface faces the closed end; and
Feature 13: the circuit board is press-fitted in the internal space while pressing the first protrusion toward (or against) the inner peripheral surface.

In the job-site device including at least Features 1 through 13 (alternatively, at least Features 1 through 9 and 13), the circuit board can be fixed inside the optical indicator without use of a screw. Moreover, there is no need to leave a space inside the optical indicator for housing the screw or to design the optical indicator so as not to make the screw visible via the container, which can offer greater flexibility in designing the optical indicator. In addition, since there is no need to provide a surplus area on the circuit board for inserting the screw, the circuit board can be downsized, which can consequently facilitate downsizing of the optical indicator.

Furthermore, the first protrusion is shorter in the direction along the perimeter of the peripheral wall than the perimeter of the inner peripheral surface. Therefore, this can reduce a force required to press-fit the circuit board in the internal space in assembling the optical indicator.

One embodiment may include, in addition to or in place of at least any one of Features 1 through 13,
Feature 14: the inner peripheral surface of the peripheral wall includes a seating (i) protruding toward the internal space and (ii) contacting the first surface of the circuit board.

In the job-site device including at least Features 1 through 14 (alternatively, at least Features 1 through 9, 13, and 14), the seating enables stable fixation of the circuit board.

One embodiment may include, in addition to or in place of at least any one of Features 1 through 14,
Feature 15: the seating surrounds the internal space.

In the job-site device including at least Features 1 through 15 (alternatively, at least Features 1 through 9 and 13 through 15), the seating as above enables more stable fixation of the circuit board.

One embodiment may include, in addition to or in place of Features 1 through 15, at least any one of:
Feature 16: the seating includes a recess surrounding the first protrusion; and
Feature 17: the first protrusion extends from the recess toward the open end.

In the job-site device including at least Features 1 through 14, 16, and 17 (alternatively, at least Features 1 through 9, 13, and 16), when the circuit board is press-fitted in the internal space, friction between the first protrusion and the circuit board may peel off a part of the first protrusion or the circuit board but the peeled part can be received in the recess. Therefore, since the peeled part is inhibited from being scattered inside the optical indicator, occurrence of a malfunction of the optical indicator can be inhibited.

One embodiment may include, in addition to or in place of at least any one of Features 1 through 17,
Feature 18: the first protrusion extends toward the open end but unreaches the open end.

In the job-site device including at least Features 1 through 14 and 18 (alternatively, at least Features 1 through 9, 13, and 18), friction between the first protrusion and the circuit board does not occur from the open end when the circuit board is press-fitted in the internal space. Therefore, a force required to press-fit the circuit board in the internal space can be reduced.

One embodiment may include, in addition to or in place of at least any one of Features 1 through 18,
Feature 19: the first protrusion extends toward the open end beyond a thickness of the circuit board.

In the job-site device including at least Features 1 through 14, 18, and 19 (alternatively, at least Features 1 through 9, 13, 18, and 19), the first protrusion, which extends beyond the thickness of the circuit board, enables stable fixation of the circuit board in the internal space.

One embodiment may include, in addition to or in place of at least any one of Features 1 through 19, at least any one of:
Feature 20: the inner peripheral surface of the peripheral wall includes a second protrusion (i) protruding toward the internal space and (ii) being shorter in the direction along the perimeter of the peripheral wall than the perimeter of the inner peripheral surface; and
Feature 21: the circuit board includes a notch engaged with the second protrusion.

In the job-site device including at least Features 1 through 14, 20, and 21 (alternatively, at least Features 1 through 9, 13, 20, and 21), the circuit board can be properly positioned in the internal space.

One embodiment may include, in addition to or in place of at least any one of Features 1 through 21, at least any one of:
Feature 22: the opening has a two-dimensional shape (or a plane shape) that is line-symmetric about (or with respect to) a specific axis; and
Feature 23: in a view from the opening, (i) the first protrusion and the second protrusion face each other, (ii) the first protrusion is situated on the specific axis, and (iii) the second protrusion deviates from the specific axis.

In the job-site device including at least Features 1 through 14 and 20 through 23 (alternatively, at least Features 1 through 9, 13, and 20 through 23), the circuit board can be inhibited from being press-fitted in the internal space in an inappropriate orientation.

Examples of the two-dimensional shape of the opening include a rectangle, a square, a circle, and an ellipse (or an oval).

One embodiment may include, in addition to or in place of at least any one of Features 1 through 23, at least any one of:
Feature 24: in a view from the opening, (i) the first protrusion and the second protrusion face each other, (ii) the first protrusion deviates from the specific axis by a first distance, and (iii) the second protrusion deviates from the specific axis by a second distance; and
Feature 25: the first distance is different from the second distance.

In the job-site device including at least Features 1 through 14, 20 through 22, 24, and 25 (alternatively, at least Features 1 through 9, 13, 20 through 22, 24, and 25), the circuit board can be inhibited from being press-fitted in the internal space in an inappropriate orientation.

One embodiment may include, in addition to or in place of at least any one of Features 1 through 25, at least any one of:
Feature 26: the first protrusion protrudes toward the internal space by a first length;
Feature 27: the second protrusion protrudes toward the internal space by a second length; and
Feature 28: the second length is greater than the first length.

In the job-site device including at least Features 1 through 14, 20, 21, and 26 through 28 (alternatively, at least Features 1 through 9, 13, 20, 21, and 26 through 28), the circuit board can be press-fitted in the internal space with a little force while being properly positioned.

One embodiment may include, in addition to or in place of at least any one of Features 1 through 28, at least any one of:
Feature 29: the circuit board includes a first outer edge contacting the first protrusion;
Feature 30: the circuit board includes a second outer edge opposite to the first outer edge; and
Feature 31: the first outer edge and the second outer edge are shaped by a router.

In the job-site device including at least Features 1 through 14 and 29 through 31 (alternatively, at least Features 1 through 9, 13, and 29 through 31), the first outer edge and the second outer edge are arranged at their respective accurate positions, and as a result, the circuit board can be press-fitted at its accurate position in the internal space.

One embodiment may include, in addition to or in place of at least any one of Features 1 through 31, at least any one of:
Feature 32: the first surface of the circuit board includes a second light source in addition to the first light source;
Feature 33: the container includes a first display portion configured to be illuminated by the first light source; and
Feature 34: the container includes a second display portion configured to be illuminated by the second light source.

In the job-site device including at least Features 1 through 14 and 32 through 34, two types of information can be displayed via the first display portion and the second display portion.

Examples of the first light source and the second light source include a light emitting diode (LED), an organic light emitting diode (OLED), and an electric bulb.

One embodiment may include, in addition to or in place of at least any one of Features 1 through 34, at least any one of:
Feature 35: the container includes an inner wall (i) dividing the internal space into a first divided space and a second divided space and (ii) configured to shield light between the first divided space and the second divided space;
Feature 36: the first divided space corresponds to the first display portion; and
Feature 37: the second divided space corresponds to the second display portion.

In the job-site device including at least Features 1 through 14 and 32 through 37, the first display portion can be inhibited from being illuminated by the second light source and the second display portion can also be inhibited from being illuminated by the first light source.

One embodiment may include, in addition to or in place of at least any one of Features 1 through 37,
Feature 38: the inner wall includes an end contacting the first surface of the circuit board between the first light source and the second light source.

In the job-site device including at least Features 1 through 14 and 32 through 38, the light can be surely prevented from propagating between the first divided space and the second divided space. Therefore, the first display portion can be surely prevented from being illuminated by the second light source and the second display portion can also be surely prevented from being illuminated by the first light source.

One embodiment may include, in addition to or in place of at least any one of Features 1 through 38, at least any one of:
Feature 39: the container includes a first layer (i) covering the first light source and (ii) configured to diffuse light emitted from the first light source; and
Feature 40: the container includes a second layer (i) covering the first layer and (ii) configured to partially transmit therethrough the light received from the first light source via the first layer.

In the job-site device including at least Features 1 through 14, 39, and 40, the light from the first light source is diffused by the first layer and the diffused light is partially transmitted through the second layer. Consequently, this makes it difficult to visually recognize the illuminated first light source from the outside of the container, which can result in improvement in visibility of information optically provided by the optical indicator. The second layer may include, in its part through which the light from the first light source is transmitted, a letter, a sign, and/or a diagram. In this case, the letter, the sign, and/or the diagram can be displayed on the container in such a way that they pop up on the container when the first light source is illuminated.

One embodiment may include, in addition to or in place of at least any one of Features 1 through 40,
Feature 41: the closed end is configured to at least partially transmit light therethrough.

In the job-site device including at least Features 1 through 14 and 41, at least a part of the closed end can be illuminated by the first light source.

One embodiment may include, in addition to or in place of at least any one of Features 1 through 41, at least any one of:
Feature 42: the circuit board includes a second surface opposite the first surface; and
Feature 43: the optical indicator includes a filler between the second surface and the open end.

In the job-site device including at least Features 1 through 14, 42, and 43, the circuit board can be more firmly fixed inside the optical indicator.

The filler may include adhesive and/or resin. Examples of the resin include a molding compound such as a thermosetting resin.

One embodiment may include, in addition to or in place of at least any one of Features 1 through 43,
Feature 44: the open end is wider than the closed end.

In the job-site device including at least Features 1 through 14 and 44 (alternatively, at least Features 1 through 9, 13, and 44), in a case where the closed end is exposed from a part of the job-site device, the wider open end is retained in the part of the job-site device. Therefore, the optical indicator can be inhibited from falling off the job-site device.

One embodiment may include, in addition to or in place of at least any one of Features 1 through 44,
Feature 45: the container at least partially has a three-dimensional shape in the form of a polyhedron, a cone, a pyramid, a frustum, or a cylinder.

One embodiment may include, in addition to or in place of at least any one of Features 1 through 45,
Feature 46: the container includes resin or glass.

Examples of the resin include polycarbonate.

One embodiment may include, in addition to or in place of at least any one of Features 1 through 46, at least any one of:
Feature 47: a grip configured to be gripped by a user of the job-site device; and
Feature 48: the grip includes the optical indicator.

In the job-site device including at least Features 1 through 14, 47, and 48 (alternatively, at least Features 1 through 9, 13, 47, and 48), the user can easily visually recognize the optical indicator during his/her use of the job-site device.

One embodiment may include, in addition to or in place of at least any one of Features 1 through 48, at least any one of:
Feature 49: an attachment configured such that a battery pack is detachably attached thereto; and
Feature 50: the circuit board is configured (i) to receive electric power from the battery pack attached to the attachment and (ii) to deliver, to the first light source, the electric power received.

In the job-site device including at least Features 1 through 14, 49, and 50 (alternatively, at least Features 1 through 9, 13, 49, and 50), the optical indicator can be illuminated by an exchangeable battery pack.

One embodiment may include, in addition to or in place of at least any one of Features 1 through 50,
Feature 51: a control circuit configured to drive the first light source in association with a state of the job-site device.

In the job-site device including at least Features 1 through 14, and 51 (alternatively, at least Features 1 through 9, 13, and 51), the optical indicator can be illuminated in accordance with the state of the job-site device.

In one embodiment, the control circuit may be integrated into a single electronic unit, a single electronic device, or a single circuit board.

In one embodiment, the control circuit may be a combination of two or more electronic circuits, two or more electronic units, or two or more electronic devices that are individually provided on or in the job-site device.

In one embodiment, the control circuit may include a microcomputer (or a microcontroller or a microprocessor), a wired logic connection, an application-specific integrated circuit (ASIC), an application-specific standard product (ASSP), a programmable logic device (such as a field programmable gate array (FPGA)), a discrete electronic component, and/or a combination of the above.

One embodiment may provide a method including at least any one of:
Feature 52: preparing a container for an optical indicator;
Feature 53: the container includes a closed end, a peripheral wall, and an open end;
Feature 54: the container is configured to at least partially transmit light therethrough;
Feature 55: the peripheral wall surrounds an internal space of the container between the closed end and the open end;
Feature 56: the peripheral wall includes a protrusion on an inner peripheral surface thereof;
Feature 57: the protrusion protrudes toward the internal space;
Feature 58: the protrusion is shorter in a direction along a perimeter of the peripheral wall than a perimeter of the inner peripheral surface; and
Feature 59: press-fitting a circuit board in the internal space from the open end while pressing the protrusion with the circuit board toward (or against) the inner peripheral surface.

According to the method including at least Features 52 through 59, the circuit board can be fixed inside the optical indicator without use of a screw. Moreover, since the protrusion is shorter in the direction along the perimeter of the peripheral wall than the perimeter of the inner peripheral surface, the circuit board can be press-fitted in the internal space with a smaller force.

Examples of the job-site device include a device configured to be used at a job-site such as home carpentry, manufacturing, gardening, and construction; specifically, power tools for stone processing, metal processing, and wood processing, a power tool for gardening, a power tool for creating an environment of a job-site, a lighting for work, a radio, a battery-powered wheelbarrow (or a battery-powered dolly), an electric hot/cold storage, a battery pack, and a battery charger. Examples of the above power tools include an electric blower, an electric hammer, an electric hammer drill, an electric drill, an electric driver, an electric wrench, an electric grinder, an electric circular saw, an electric reciprocating saw, an electric jigsaw, an electric cutter, an electric chain saw, an electric planer, an electric nailer (including an electric tacker), an electric hedge trimmer, an electric lawn mower, an electric lawn trimmer, an electric grass cutter (or an electric brush cutter, or an electric string trimmer, or an electric grass trimmer), an electric cleaner, an electric sprayer, and an electric spreader.

In one embodiment, Features 1 through 59 may be combined in any combination.

In one embodiment, any of Features 1 through 59 may be excluded.

### 2. Specific Example Embodiment

Hereinafter, a description is given to a specific example embodiment. The specific example embodiment provides a job-site device 1 in the form of an electric grass cutter. However, such a job-site device 1 is merely an example, and the present disclosure can be applied to a job-site device in various forms.

### 2-1. Overall Structure of Job-site Device

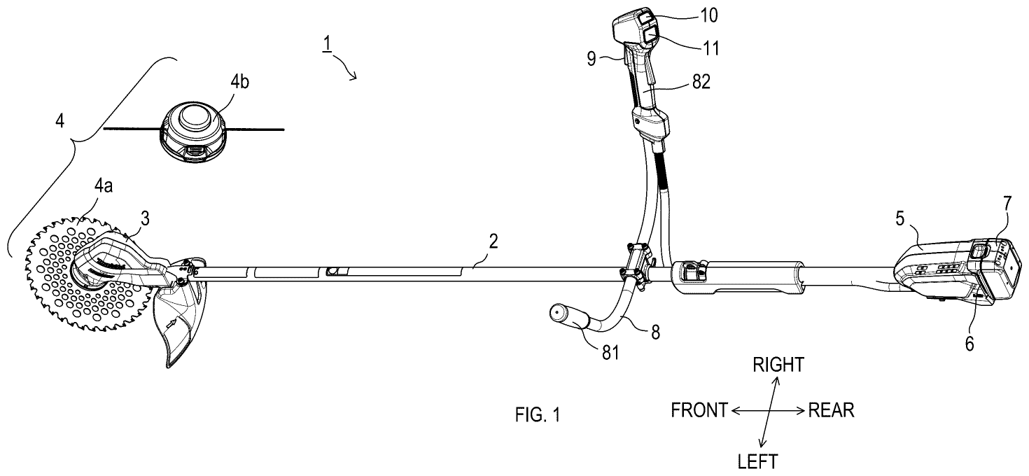

As illustrated in FIG. 1, the job-site device 1 includes a main pipe 2. In the present embodiment, the main pipe 2 is long and hollow.

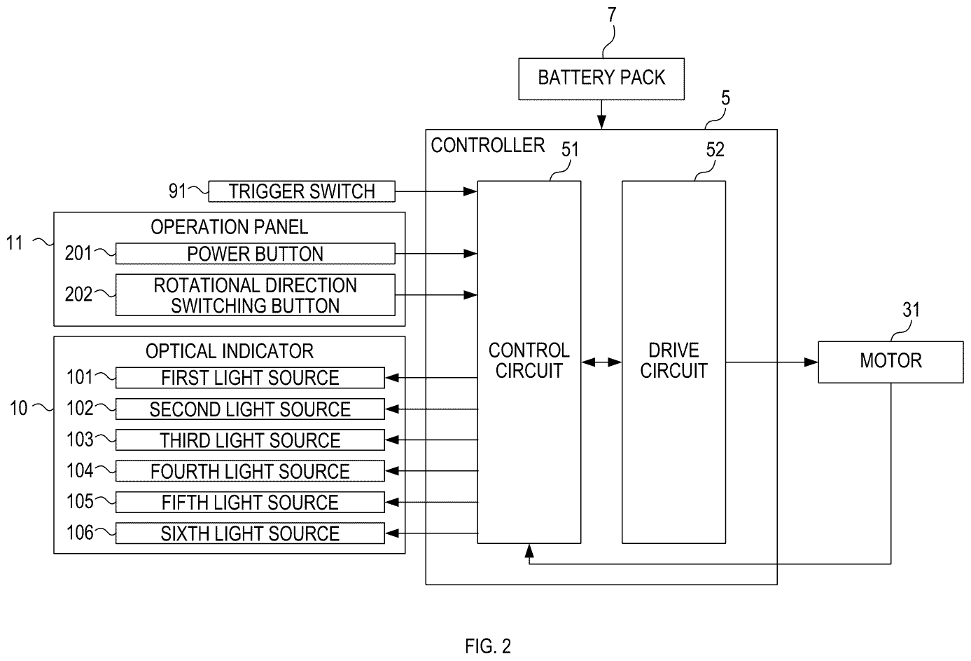

The job-site device 1 includes a motor housing 3 at a front end of the main pipe 2. The motor housing 3 houses a motor 31 (see, FIG. 2) configured to rotatably drive a cutting blade 4. The cutting blade 4 is configured to rotate to thereby cut grass, small trees, and the like. The cutting blade 4 is selected from a metal blade 4a or a nylon cord cutter 4b.

The job-site device 1 includes a controller 5 at a rear end of the main pipe 2. The controller 5 includes an attachment 6 at a rear end thereof. The attachment 6 has a battery pack 7 detachably attached thereto.

The job-site device 1 includes a handle 8 near a center of the main pipe 2 in its longitudinal direction. The handle 8 in the present embodiment intersects the main pipe 2, and is formed into a U-shape.

The handle 8 includes a left grip 81 at a left end thereof. The left grip 81 is configured to be gripped by a left hand of a user of the job-site device 1.

The handle 8 includes a right grip 82 at a right end thereof. The right grip 82 is configured to be gripped by a right hand of the user.

The right grip 82 includes a trigger 9 on a front surface thereof. The trigger 9 is configured to be pulled by a finger of the right hand of the user. The right grip 82 includes an optical indicator 10 at a leading end thereof. The optical indicator 10 is configured to optically provide information on a state of the job-site device 1. In the present embodiment, the optical indicator 10 is oriented in a direction such that the user easily visually recognizes an optical indication on the optical indicator 10 during his/her operation of the job-site device 1.

The right grip 82 further includes an operation panel 11 below the optical indicator 10.

### 2-2. Electrical Configuration of Job-site Device

As illustrated in FIG. 2, the job-site device 1 includes a trigger switch 91 configured to output a trigger signal in response to the trigger 9 being pulled.

The operation panel 11 includes a power button 201 to be pressed by the user so as to turn on or off the job-site device 1. The power button 201 is configured to output a power command signal in response to the power button 201 being pressed.

The operation panel 11 includes a rotational direction switching button 202 to be pressed by the user so as to switch rotational directions of the cutting blade 4 from a forward direction to a reverse direction or from the reverse direction to the forward direction. The rotational direction switching button 202 is configured to output a rotational direction switching signal in response to the rotational direction switching button 202 being pressed.

The optical indicator 10 includes first through sixth light sources 101 through 106. In the present embodiment, each of the first through sixth light sources 101 through 106 is an LED. In another embodiment, at least one of the first through sixth light sources 101 through 106 may be an OLDE or an electric bulb.

The controller 5 includes a control circuit 51. The control circuit 51 is configured to operate by receiving DC power from the battery pack 7 attached to the attachment 6.

More specifically, the control circuit 51 is configured to receive the power command signal, to thereby be activated or deactivated. Furthermore, the control circuit 51 is configured to receive the trigger signal, the rotational direction switching signal, a rotational position signal, and a current measurement signal, to thereby output a motor control signal. The motor control signal indicates a rotational speed of the motor 31 and a rotational direction of the motor 31. The rotational position signal indicates a rotational position of a not-shown rotor of the motor 31, and is delivered from the motor 31 to the control circuit 51. The current measurement signal indicates a magnitude of an electric current flowing through the motor 31.

Still further, the control circuit 51 is configured to monitor the state of the job-site device 1 (for example, a magnitude of a voltage of the battery pack 7 and the magnitude of the electric current flowing through the motor 31) and to drive the first through sixth light sources 101 through 106 based on the state of the job-site device 1. The first through sixth light sources 101 through 106 are configured to be illuminated by individual electric currents delivered from the control circuit 51.

In the present embodiment, the control circuit 51 includes a not-shown microcomputer. In another embodiment, the control circuit 51 may include an additional microcomputer. In still another embodiment, the control circuit 51 may include, in addition to or in place of the microcomputer, a logic circuit (or a wired logic connection) including two or more electronic components. In still another embodiment, the control circuit 51 may include, in addition to or in place of the microcomputer, an ASIC and/or an ASSP. In still another embodiment, the control circuit 51 may include, in addition to or in place of the microcomputer, a programmable logic device on which a reconfigurable logic circuit can be configured. Examples of the programmable logic device include a FPGA.

The controller 5 includes a drive circuit 52. The drive circuit 52 is configured (i) to receive the above-described motor control signal from the control circuit 51 and (ii) to drive the motor 31 in accordance with the motor control signal received. The motor 31 rotates by receiving the DC power of the battery pack 7 via the drive circuit 52.

Furthermore, the drive circuit 52 is configured to measure the magnitude of the electric current flowing through the motor 31 and to output the above-described current measurement signal to the control circuit 51.

### 2-3. Details of Optical Indicator

Hereinafter, languages “up”, “down”, “front”, “rear”, “left”, and “right” in a description are merely used to facilitate easy understanding of a structure of the optical indicator 10. Such languages do not intend to limit the orientation of the optical indicator 10. The optical indicator 10 can be arranged in any orientation.

### 2-3-1. Overall Structure of Optical Indicator

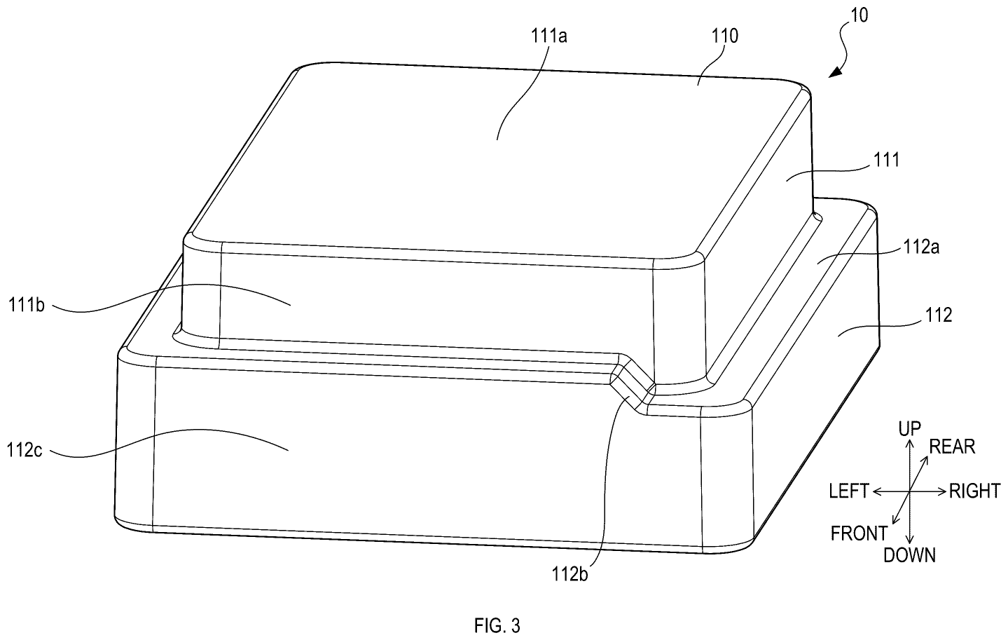

As illustrated in FIG. 3, the optical indicator 10 includes a container 110. In the present embodiment, the container 110 is a resin-made container configured to transmit light therethrough. In another embodiment, the container 110 may be a glass-made container configured to transmit light therethrough.

The container 110 has a polyhedral three-dimensional shape. More specifically, the container 110 includes a top part 111 in the form of a substantially rectangular parallelepiped. The top part 111 includes a first upper surface 111a that closes a top end thereof. The first upper surface 111a has a two-dimensional shape of rectangular with four round corners. The top part 111 further includes a first peripheral wall 111b that extends along an outer peripheral edge of the first upper surface 111a and surrounds an internal space of the top part 111.

The container 110 further includes a base part 112 that extends from the top part 111 to a front side, a rear side, a left side, a right side, and a lower side. The base part 112 includes a second upper surface 112a that includes a slanting part 112b on each of the front and rear sides of the base part 112 (FIG. 3 only illustrates the slanting part 112b on the front side). The base part 112 further includes a second peripheral wall 112c that extends along an outer peripheral edge of the second upper surface 112a and surrounds an internal space of the base part 112.

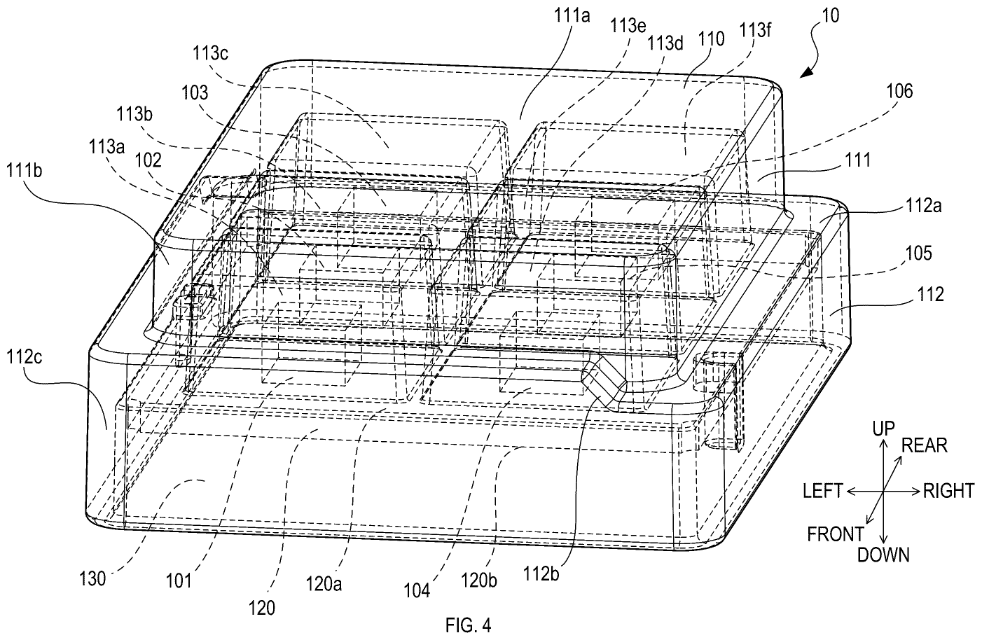

As illustrated in FIG. 4, the optical indicator 10 includes a circuit board 120 inside the container 110. The circuit board 120 includes a first surface 120a facing toward the first upper surface 111a. The first surface 120a includes the above-described first through sixth light sources 101 through 106 thereon. In the present embodiment, the first through third light sources 101 through 103 are aligned in a left-side area on the first surface 120a from the front side to the rear side. The fourth through sixth light sources 104 through 106 are aligned in a right-side area on the first surface 120a from the front side to the rear side.

The container 110 includes first through sixth display portions 113a though 113f corresponding to the first through sixth light sources 101 through 106, respectively. The first through sixth display portions 113a through 113f house the first through sixth light sources 101 through 106, respectively, and are configured to be illuminated by the first through sixth light sources 101 through 106, respectively.

The circuit board 120 includes a second surface 120b opposite the first surface 120a. Under the circuit board 120, the optical indicator 10 includes a filler 130 that seals the container 110. In the present embodiment, the filler 130 is, but not limited to, an adhesive. In another embodiment, the filler 130 may be a molding compound such as a thermosetting resin.

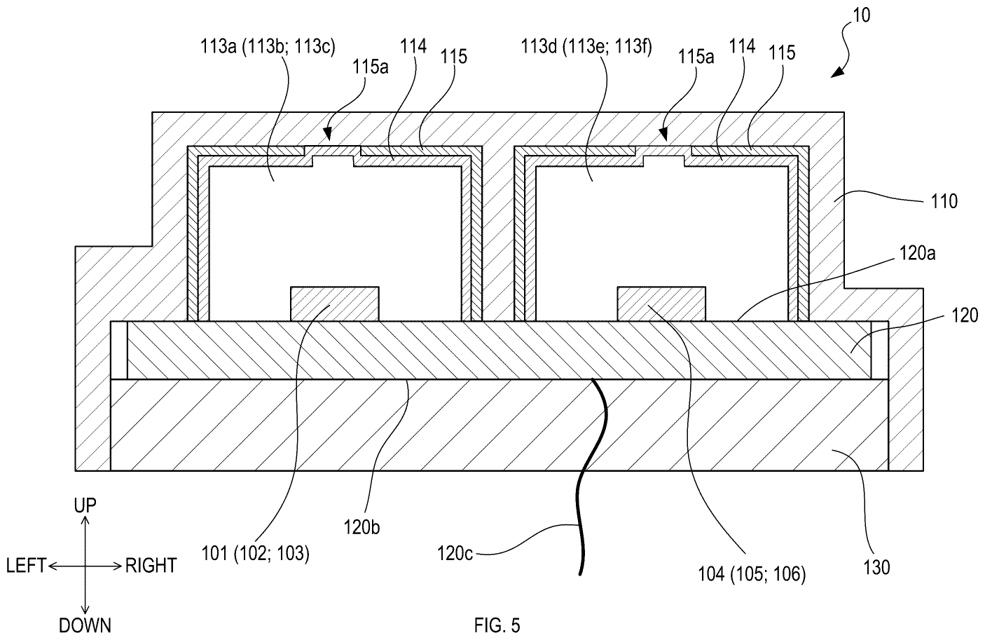

As illustrated in FIG. 5, each of the first through sixth display portions 113a through 113f includes a first layer 114 that covers a corresponding one of the first through sixth light sources 101 through 106. The first layer 114 is configured to diffuse light emitted from the corresponding one of the first through sixth light sources 101 through 106.

Furthermore, each of the first through sixth display portions 113a through 113f includes a second layer 115 covering the first layer 114. The second layer 115 is configured to partially transmit therethrough the light received from the corresponding one of the first through sixth light sources 101 through 106 via the first layer 114. More specifically, the second layer 115 includes a hole 115a in a top part thereof. The second layer 115 is configured to transmit therethrough the light through the hole 115a. The hole 115a has a two-dimensional shape representing a letter, a sign, and/or a diagram. In the present embodiment, the hole 115a is filled with the first layer 114. In another embodiment, the hole 115a may be a gap.

The optical indicator 10 includes two or more lead wires 120c (FIG. 5 illustrates only one lead wire 120c) for delivering the electric currents from the control circuit 51 to the first through sixth light sources 101 through 106. The two or more lead wires 120c are electrically coupled to the first through sixth light sources 101 through 106, respectively, via the circuit board 120. The two or more lead wires 120c are led out of the optical indicator 10 from the second surface 120b of the circuit board 120 via the filler 130.

### 2-3-2. Details of Structure of Container

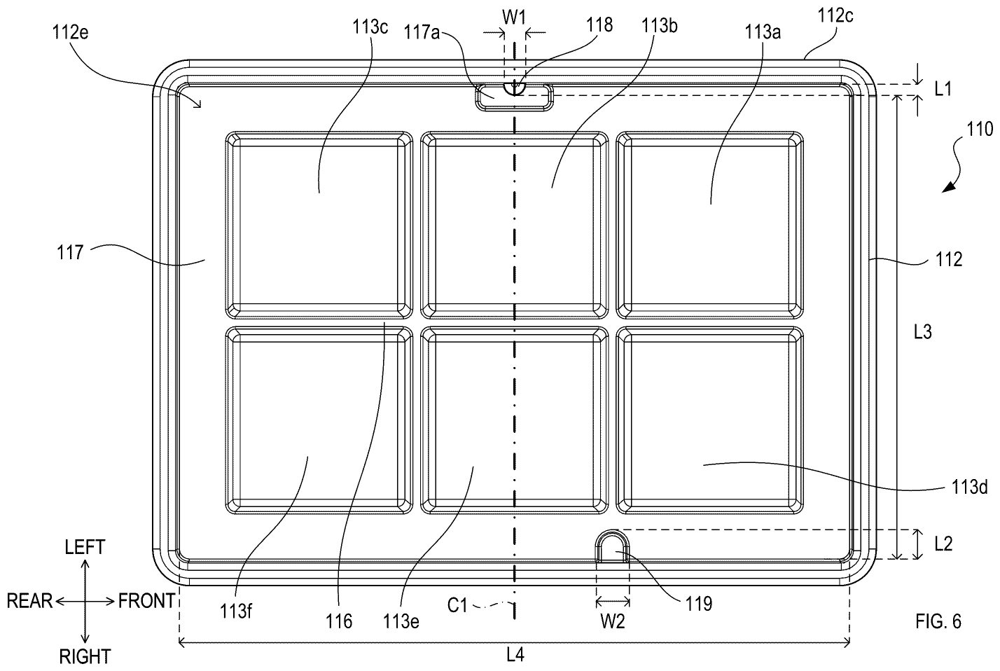

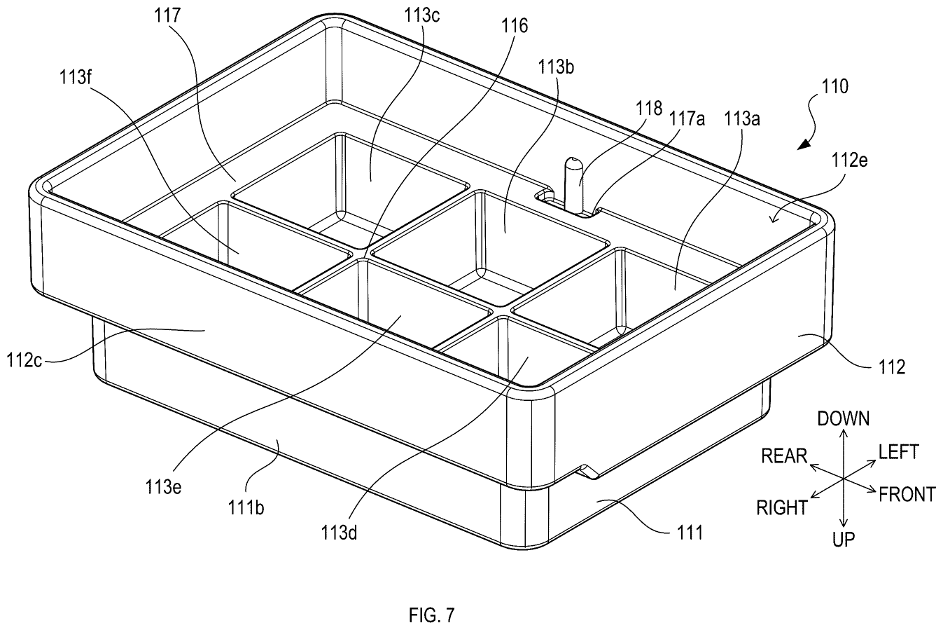

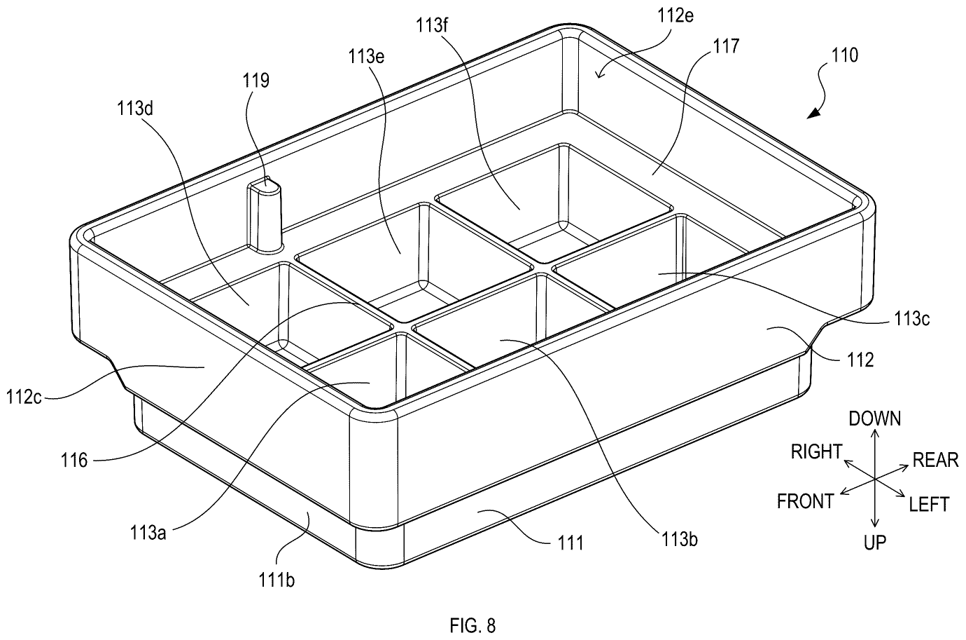

As illustrated in FIGS. 6 through 8, in a view of the container 110 from below, the base part 112 of the container 110 includes an opening 112e for accommodating (or receiving) the circuit board 120 and the filler 130. The opening 112e has a substantially rectangular plane shape that is line-symmetric about a first imaginary axis C1. The first imaginary axis C1 passes a center of a left peripheral wall of the second peripheral wall 112c and a center of a right peripheral wall of the second peripheral wall 112c.

The container 110 includes a seating 117 (i) protruding from an inner peripheral surface of the second peripheral wall 112c toward an internal space of the container 110 and (ii) configured to contact the first surface 120a of the circuit board 120. The seating 117 is located on an underside of the second upper surface 112a of the base part 112 and surrounds the internal space of the container 110.

The container 110 includes a first protrusion (or a first rib) 118 at the center of the left peripheral wall of the second peripheral wall 112c, that is, on the first imaginary axis C1. The first protrusion 118 protrudes from the inner peripheral surface of the second peripheral wall 112c toward the internal space by a first length L1. The first protrusion 118 has a length (that is, a first width) W1 shorter than a fourth length L4 of an inner peripheral surface of the left peripheral wall of the second peripheral wall 112c. The seating 117 includes a recess 117a that surrounds the first protrusion 118.

In the present embodiment, the first protrusion 118 extends from the recess 117a toward an open end of the base part 112 beyond a thickness of the circuit board 120 but unreaches the open end. In another embodiment, the first protrusion 118 may extend toward the open end so as not to exceed the thickness of the circuit board 120. In still another embodiment, the first protrusion 118 may reach the open end of the base part 112.

The container 110 includes a second protrusion (or a second rib) 119 on the right peripheral wall of the second peripheral wall 112c. The second protrusion 119 is opposite to the first protrusion 118 and deviates from the first imaginary axis C1 toward the front side. The second protrusion 119 protrudes from the inner peripheral surface of the second peripheral wall 112c toward the internal space by a second length L2. The second length L2 is greater than the first length L1. The second protrusion 119 has a length (that is, a second width) W2 shorter than the fourth length L4 of an inner peripheral surface of the right peripheral wall of the second peripheral wall 112c. The second width W2 is greater than the first width W1.

In the present embodiment, the second protrusion 119 extends from the seating 117 toward the open end of the base part 112 beyond the thickness of the circuit board 120 but unreaches the open end. In another embodiment, the second protrusion 119 may extend toward the open end so as not to exceed the thickness of the circuit board 120. In still another embodiment, the second protrusion 119 may reach the open end of the base part 112.

The container 110 includes an inner wall 116 that (i) divides the internal space surrounded by the first peripheral wall 111b of the top part 111 into the first through sixth display portions 113a through 113f, and (ii) is configured to shield the light among the first through sixth display portions 113a through 113f. A lower end of the inner wall 116 is located at the same height as the seating 117 and contacts the first surface 120a of the circuit board 120.

### 2-3-3. Details of Structure of Circuit Board

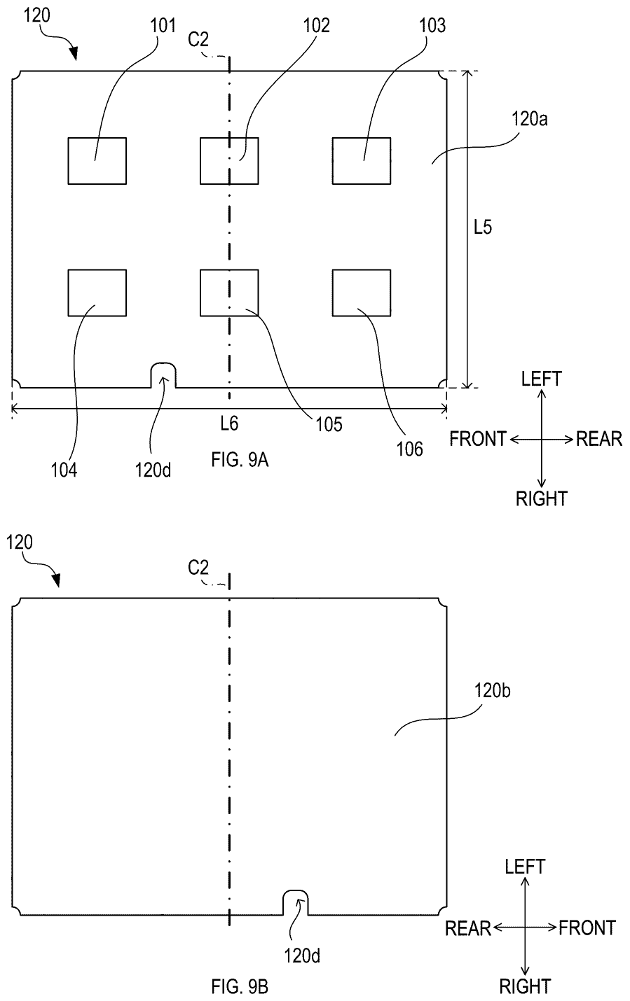

As illustrated in FIGS. 9A and 9B, the circuit board 120 has a substantially rectangular plane shape that is line-symmetric about a second imaginary axis C2. The second imaginary axis C2 passes a center of a left outer edge of the circuit board 120 and a center of a right outer edge of the circuit board 120. In a view of the circuit board 120 housed inside the container 110 from the opening 112e, the second imaginary axis C2 substantially coincides with the first imaginary axis C1.

Each of the left outer edge and the right outer edge of the circuit board 120 has a sixth length L6 that is slightly shorter than the fourth length L4 of each of the inner peripheral surface of the left peripheral wall and the inner peripheral surface of the right peripheral wall of the second peripheral wall 112c.

Each of a front outer edge and a rear outer edge of the circuit board 120 has a fifth length L5 that is slightly greater than a third length L3 in FIG. 6. The third length L3 corresponds to a length obtained by subtracting the first length L1 of the first protrusion 118 from a length of an inner peripheral surface of a front peripheral wall of the second peripheral wall 112c.

The circuit board 120 includes a notch 120d in the right outer edge. The notch 120d deviates from the second imaginary axis C2 toward the front side.

At least the left outer edge, the right outer edge, and the notch 120d of the circuit board 120 are shaped by a router.

### 2-3-4. Assembling Process of Optical Indicator

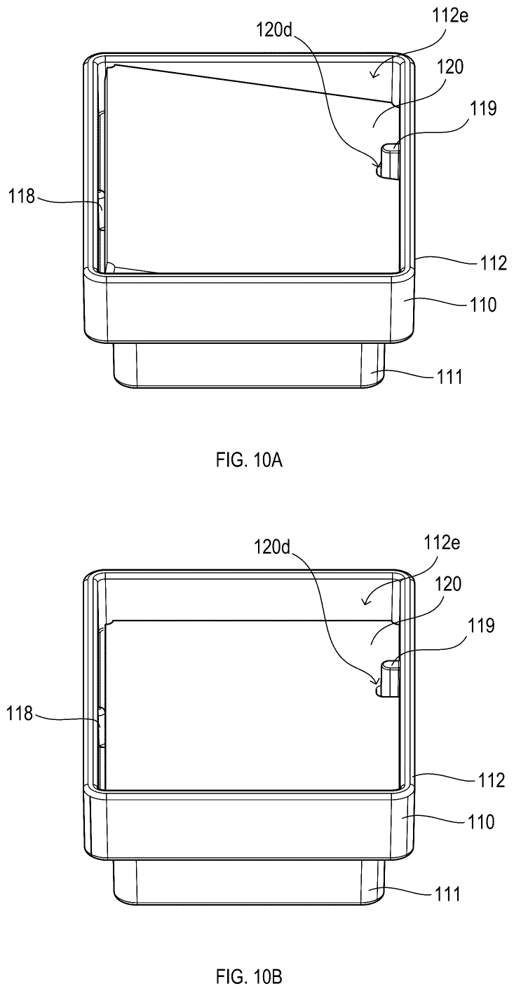

In assembling the optical indicator 10, as illustrated in FIG. 10A, the circuit board 120 is obliquely inserted into the opening 112e of the container 110, and the notch 120d of the circuit board 120 is engaged with the second protrusion 119. Subsequently, as illustrated in FIG. 10B, the circuit board 120 is press-fitted (lightly press-fitted) with a little force in the internal space of the container 110 about the right outer edge of the circuit board 120 so that the left outer edge of the circuit board 120 presses the first protrusion 118 toward (or against) the inner peripheral surface of the second peripheral wall 112c. Upon completion of press-fitting of the circuit board 120, the opening 112e is applied with the filler 130 in the form of a paste while the two or more lead wires 120c (not shown) are led out of the opening 112e. Upon the filler 130 being cured, the opening 112e of the container 110 is sealed with the filler 130 and assembly of the optical indicator 10 completes.

### 2-4. Technical Effects in Embodiment

In the job-site device 1 configured as above, the circuit board 120 can be fixed inside the optical indicator 10 without use of a screw. In addition, there is no need to leave a space inside the optical indicator 10 for housing a screw or to design the optical indicator 10 so as not to make a screw visible via the container 110, which can offer greater flexibility in designing the optical indicator 10. Moreover, since there is no need to provide a surplus area on the circuit board 120 for inserting a screw, the circuit board 120 can be downsized, which can consequently facilitate downsizing of the optical indicator 10.

Furthermore, in the job-site device 1, the seating 17 can provide stable fixation of the circuit board 120 inside the optical indicator 10.

Still further, in the job-site device 1, when the circuit board 120 is press-fitted in the internal space of the container 110, there is a possibility where friction between the first protrusion 118 and the circuit board 120 peels off a part of the first protrusion 118 or the circuit board 120. In this case, the peeled part can be received inside the recess 117a. Therefore, since the peeled part is inhibited from being scattered inside the optical indicator 10, occurrence of a malfunction of the optical indicator 10 can be inhibited.

Still further, in the job-site device 1, since the first protrusion 118 unreaches the open end of the container 110, a force required to press-fit the circuit board 120 in the internal space of the container 110 can be reduced.

Still further, in the job-site device 1, the first protrusion 118, which extends beyond the thickness of the circuit board 120, enables stable fixation of the circuit board 120 in the internal space of the container 110.

Still further, in the job-site device 1, engagement between the second protrusion 119 and the notch 120d enables appropriate positioning of the circuit board 120 in the internal space of the container 110.

Still further, in the job-site device 1, since the second protrusion 119 deviates from the first imaginary axis C1, the circuit board 120 can be inhibited from being press-fitted in the internal space of the container 110 in an inappropriate orientation when the optical indicator 10 is assembled.

Still further, in the job-site device 1, since the second length L2 of the second protrusion 119 is greater than the first length L1 of the first protrusion 118, the circuit board 120 can be appropriately positioned while being press-fitted with a little force in the internal space of the container 110.

Still further, in the job-site device 1, at least the left outer edge, the right outer edge, and the notch 120d of the circuit board 120 are shaped by the router. Therefore, the left outer edge and the right outer edge of the circuit board 120 can be arranged at their respective accurate positions, and as a result, the circuit board 120 can be press-fitted at its accurate position in the internal space of the container 110.

Still further, in the job-site device 1, the inner wall 116 can surely prevent the light from propagating among the first through sixth display portions 113a through 113f.

Still further, in the job-site device 1, the first layer 114 and the second layer 115 cause difficulty in visually recognizing the illuminated light source of each of the first through sixth display portions 113a through 113f from the outside of the container 110. Consequently, this can improve visibility of the information optically provided by the optical indicator 10. In each of the first through sixth display portions 113a through 113f, a letter, a sign, and/or a diagram can be displayed on the container 110 in such a way that they pop up on the container 110 when the corresponding one of the first through sixth light sources 101 through 106 is illuminated.

Still further, in the job-site device 1, the circuit board 120 can be firmly fixed inside the optical indicator 10 with the filler 130.

Still further, in the job-site device 1, the base part 112 of the container 110 is wider than the top part 111 of the container 110. Thus, in a case where the first upper surface 111a of the top part 111 is exposed from a part of the right grip 82 of the job-site device 1, the base part 112 is retained in the part of the right grip 82. Therefore, the optical indicator 10 can be inhibited from falling off the right grip 82.

### 2-5. Correspondence Between Terms

In the aforementioned embodiments, the left outer edge and the right outer edge of the circuit board 120 correspond to one example of the first outer edge and one example of the second outer edge, respectively, in the overview of embodiments. Any one of the first through sixth light sources 101 through 106 corresponds to one example of the first light source in the overview of embodiments; and any other one of the first through sixth light sources 101 through 106 corresponds to one example of the second light source in the overview of embodiments. Any one of the first through sixth display portions 113a through 113f corresponds to one example of the first display portion in the overview of embodiments; and any other one of the first through sixth display portions 113a through 113f corresponds to one example of the second display portion in the overview of embodiments. Any one of the first through sixth display portions 113a through 113f corresponds to one example of the first divided space in the overview of embodiments; and any other one of the first through sixth display portions 113a through 113f corresponds to one example of the second divided space in the overview of embodiments.

### 2-6. Variations

The present disclosure is not limited to the above-described embodiments and can be implemented in various forms.

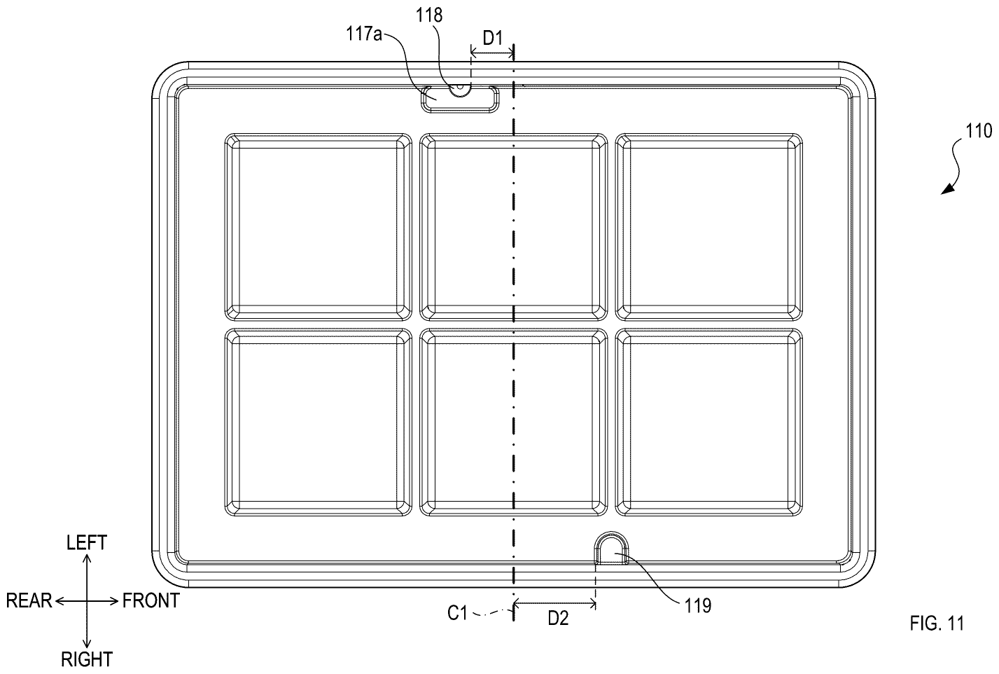

As illustrated in FIG. 11, in one variation, the first protrusion 118 may deviate together with the recess 117a from the first imaginary axis C1 toward the rear side by a first distance D1. The first distance DI may be different from a second distance D2 by which the second protrusion 119 deviates from the first imaginary axis C1. When the first distance D1 and the second distance D2 are different from each other, the first protrusion 118 does not coincide with the notch 120d of the circuit board 120 in any orientations of the circuit board 120. Therefore, the circuit board 120 can be inhibited from being press-fitted inside the container 110 in an inappropriate orientation.

In one variation, the second peripheral wall 112c may include, on its inner peripheral surface, an additional protrusion configured to function similarly to the first protrusion 118 or the second protrusion 119.

In one variation, the first protrusion 118 may deviate from the first imaginary axis C1 toward the front side by the distance D1 and/or the second protrusion 119 may deviate from the first imaginary axis C1 toward the rear side by the second distance D2.

In one variation, the container 110 and/or the circuit board 120 may be configured such that the circuit board 120 is press-fitted inside the container 110 in such a manner that the first surface 120a of the circuit board 120 does not face toward the first upper surface 111a of the container 110.

In one variation, the container 110 may at least partially have a three-dimensional shape in the form of a cone, a pyramid, a frustum, or a cylinder.

In one variation, the opening 112e may have a two-dimensional shape in the form of a square, a circle, or an ellipse.

In one variation, the second protrusion 119 and the notch 120d may be eliminated.

### 2-7. Supplementary Explanation

Two or more functions of one element in the aforementioned embodiments may be achieved by two or more elements, and one function of one element may be achieved by two or more elements. Furthermore, two or more functions of two or more elements may be achieved by one element, and one function achieved by two or more elements may be achieved by one element. A part of the configurations in the aforementioned embodiments may be omitted. Furthermore, at least a part of the configurations in the aforementioned embodiments may be added to or replaced by another configuration in the above-described embodiments.

What is claimed is:

1. A job-site device, comprising:
an optical indicator including:
a container (i) including a closed end, a peripheral wall, and an open end with an opening and (ii) configured to at least partially transmit light therethrough, the peripheral wall (i) surrounding an internal space of the container between the closed end and the open end and (ii) including a first protrusion on an inner peripheral surface thereof, the first protrusion (i) protruding toward the internal space and (ii) being shorter in a direction along a perimeter of the peripheral wall than a perimeter of the inner peripheral surface; and
a circuit board including a first surface (i) including a first light source and (ii) facing the closed end, the circuit board being press-fitted in the internal space while pressing the first protrusion toward the inner peripheral surface.

2. The job-site device according to claim 1,
wherein the inner peripheral surface of the peripheral wall includes a seating (i) protruding toward the internal space and (ii) contacting the first surface of the circuit board.

3. The job-site device according to claim 2,
wherein the seating surrounds the internal space.

4. The job-site device according to claim 2, wherein:
the seating includes a recess that surrounds the first protrusion; and
the first protrusion extends from the recess toward the open end.

5. The job-site device according to claim 1,
wherein the first protrusion extends toward the open end but unreaches the open end.

6. The job-site device according to claim 5,
wherein the first protrusion extends toward the open end beyond a thickness of the circuit board.

7. The job-site device according to claim 1, wherein:
the inner peripheral surface of the peripheral wall includes a second protrusion (i) protruding toward the internal space and (ii) being shorter in the direction along the perimeter of the peripheral wall than the perimeter of the inner peripheral surface; and
the circuit board includes a notch engaged with the second protrusion.

8. The job-site device according to claim 7, wherein:
the opening has a two-dimensional shape that is line-symmetric about a specific axis; and
in a view from the opening, (i) the first protrusion and the second protrusion face each other, (ii) the first protrusion is situated on the specific axis, and (iii) the second protrusion deviates from the specific axis.

9. The job-site device according to claim 7, wherein:
the opening has a two-dimensional shape that is line-symmetric about a specific axis; and
in a view from the opening, (i) the first protrusion and the second protrusion face each other, (ii) the first protrusion deviates from the specific axis by a first distance, (iii) the second protrusion deviates from the specific axis by a second distance, and (iv) the first distance is different from the second distance.

10. The job-site device according to claim 7, wherein:
the first protrusion protrudes toward the internal space by a first length;
the second protrusion protrudes toward the internal space by a second length; and
the second length is greater than the first length.

11. The job-site device according to claim 1, wherein:
the circuit board includes:
a first outer edge contacting the first protrusion; and
a second outer edge opposite to the first outer edge; and
the first outer edge and the second outer edge are shaped by a router.

12. The job-site device according to claim 1, wherein:
the first surface of the circuit board includes a second light source in addition to the first light source; and
the container includes:
a first display portion configured to be illuminated by the first light source; and
a second display portion configured to be illuminated by the second light source.

13. The job-site device according to claim 12, wherein:
the container includes an inner wall (i) dividing the internal space into a first divided space and a second divided space and (ii) configured to shield light between the first divided space and the second divided space;
the first divided space corresponds to the first display portion; and
the second divided space corresponds to the second display portion.

14. The job-site device according to claim 13,
wherein the inner wall includes an end contacting the first surface of the circuit board between the first light source and the second light source.

15. The job-site device according to claim 1, wherein the container includes:
a first layer (i) covering the first light source and (ii) configured to diffuse light emitted from the first light source; and
a second layer (i) covering the first layer and (ii) configured to partially transmit therethrough the light received from the first light source via the first layer.

16. The job-site device according to claim 1,
wherein the closed end is configured to at least partially transmit light therethrough.

17. The job-site device according to claim 1, wherein:
the circuit board includes a second surface opposite the first surface; and
the optical indicator includes a filler between the second surface and the open end.

18. The job-site device according to claim 1,
wherein the open end is wider than the closed end.

19. The job-site device according to claim 1, further comprising a grip configured to be gripped by a user of the job-site device,
wherein the grip includes the optical indicator.

20. The job-site device according to claim 1, further comprising an attachment configured such that a battery pack is detachably attached thereto,
wherein the circuit board is configured (i) to receive electric power from the battery pack attached to the attachment and (ii) to deliver, to the first light source, the electric power received.

21. The job-site device according to claim 1, further comprising a control circuit configured to drive the first light source in association with a state of the job-site device.

22. A method for fixing a circuit board inside an optical indicator of a job-site device, the method comprising:
preparing a container for the optical indicator, the container (i) including a closed end, a peripheral wall, and an open end and (ii) being configured to at least partially transmit light therethrough, the peripheral wall (i) surrounding an internal space of the container between the closed end and the open end and (ii) including a protrusion on an inner peripheral surface thereof, the protrusion (i) protruding toward the internal space and (ii) being shorter in a direction along a perimeter of the peripheral wall than a perimeter of the inner peripheral surface; and
press-fitting the circuit board in the internal space from the open end while pressing the protrusion with the circuit board toward the inner peripheral surface.
